(19) United States
(12) Patent Application Publication
(10) Pub. No.: US 2002/0108505 A1
(43) Pub. Date: Aug. 15, 2002

(54) Production process for foodstuff fermenting agents

(76) Inventors: Elsa Ostermann, Bethune (FR); Bernard Pora, Arleux (FR); Bernard Boursier, Violaines (FR); Sophie Defretin, Locon (FR); Daniel Wils, Morbecque (FR)

Correspondence Address: Michael O. Sturm, HENDERSON & STURM, 206 Sixth Avenue, Suite 1213, Des Moines, IA, 50309-4076, US

(21) Appl. No.: 10/003,571

(22) Filed: Oct. 24, 2001

(30) Foreign Application Priority Data
Oct. 30, 2000 (FR) FR 00 13956

(51) Int. Cl. A23L 1/00

(52) U.S. Cl. 99/485

(57) ABSTRACT

The invention concerns a process for preparing food fermenting agents comprising a fermentation of lactic bacteria in a culture medium comprising at least one fermentation activator saccharide selected from the group consisting of the maltodextrins, the branched maltodextrins, the soluble starches and the oligosaccharides, on their own or in a mixture. Its subject is also a process for preserving food fermenting agents which uses at least one fermentation activator saccharide selected from the group consisting of the maltodextrins, the branched maltodextrins, the soluble starches and the oligosaccharides, on their own or in a mixture.

### FIELD OF THE INVENTION

The subject of the present invention is a production process for foodstuff fermenting agents by the fermentation of lactic bacteria in a culture medium containing a particular saccharide as a fermentation activator. Its subject is also a process for preserving foodstuff fermenting agents using the said particular saccharide. The foodstuff fermenting agents to which the present invention is directed are Gram-positive bacteria, among which are to be found the lactic bacteria characterised by the production of a large amount of lactic acid, and the bifidus bacteria which are similar to the lactic bacteria and are characterised by mixed lactic and acetic fermentation.

### BACKGROUND OF THE INVENTION

The lactic bacteria comprise the following genus types: Lactobacillus, Lactococcus, Streptococcus, Enterococcus, Leuconostoc and Pediococcus. The bifidus bacteria are represented by the Bifidobacterium genus.

These bacteria are generally found associated with other micro-organisms in numerous naturally fermented animal and vegetable products: fermented milks (cheeses, yoghurts), fermented meats (sausage, ham), fruit-based alcoholic beverages (wines, ciders, beers), fermented fruits and vegetables (sauerkraut, olives, gherkins), fermented cereals (various kinds of bread) and fermented fodder (silage).

These bacteria, which are collectively known as “foodstuff fermenting agents”, are considered to be one of the groups of bacteria that are the hardest to please from the nutritional point of view (La technique laitière No. 979, 1983—pp. 41-47).

Lactic bacteria have been used widely for a long time in the preservation of foods based on milk, meat, fish, vegetables and fruit. The most significant innovation in the area of the preparation of fermenting agents was the introduction of concentrated fermenting agents in a frozen form, and shortly afterwards in a lyophilised (freeze-dried) form. These concentrated fermenting agents greatly simplify the users' task and favour more consistent production.

The characteristics of the culture medium intended for the industrial production of lactic fermenting agents very largely govern the final activity of the product. Notwithstanding the nutritional demands of the lactic bacteria, the culture media must allow a concentrated biomass to be obtained with good production yields. The nutritional requirements are satisfied by providing the micro-organisms with one or more nitrogenous sources, a source containing carbon, vitamins, minerals, and in certain cases fatty acids, nitrogenous bases and organic acids. It is generally recommended that the carbon-containing substrates used should be the same as those contained in the media for which the fermenting agents are intended. It is often preferable to use disaccharides such as lactose, saccharose (sucrose) or maltose to obtain good final activity of the fermenting agent.

### SUMMARY OF THE INVENTION

While taking an interest in this question, the Applicant observed that the use of a family of particular saccharides in a process for producing food fermenting agents had, in a surprising and unexpected manner, a stimulating effect on the growth of the fermenting agents and consequently on the rate of acidification of the growth medium. This is particularly astonishing because it is known that low molecular weight carbon sources such as lactose in particular are preferentially metabolised by the lactic bacteria.

### DETAILED DESCRIPTION OF THE INVENTION

Thus the subject of the invention is a process for producing food fermenting agents comprising a fermentation of lactic bacteria in a culture medium comprising at least one fermentation activator saccharide selected from the group consisting of the maltodextrins, the branched maltodextrins, the soluble starches and the oligosaccharides, on their own or in a mixture. According to a preferred variant of the process according to the invention, the said fermentation activator is selected from the group consisting of the branched maltodextrins, the soluble starches and the oligosaccharides, on their own or in a mixture. According to another preferred variant of the process according to the invention, the said fermentation activator is selected from the group consisting of the soluble starches and the branched maltodextrins.

The fermentation process can be applied equally well in vitro and in vivo. Thus the saccharide fermentation activator according to the invention can favour the growth of human or animal lactic flora in vivo.

“Maltodextrins” are understood to mean the standard maltodextrins obtained classically by acidic and/or enzymatic hydrolysis of starch and characterized by a reducing power expressed as Dextrose Equivalent (or D.E.) of less than 20.

“Branched maltodextrins” are understood to mean the maltodextrins described in Patent Application FR-A-2,786,725 of which the Applicant is the owner. These maltodextrins are characterised by a content of 1→6 glucosidic bonds greater than that of standard maltodextrins. They have between 15 and 35% of 1→6 glucosidic bonds, a reducing sugars content less than 20%, a polymolecularity index less than 5 and a number average molecular mass Mn equal to at most 4,500 g/mole. They can also be hydrogenated.

“Soluble starches” are understood to mean starches of any origin, modified physically or chemically and having the ability to be soluble in water at ambient temperature.

Oligosaccharides are understood to mean in particular the fructo-oligosaccharides, the isomalto-oligosaccharides, the malto-oligosaccharides, the galacto-oligosaccharides, the xylo-oligosaccharides, the palatinose oligosides, lactulose, raffinose and lactosucrose.

Preferably, to obtain the stimulating effect sought in the preparation of the fermenting agents, the process according to the invention is characterised in that the activator saccharide is present in the culture medium at a concentration at least equal to 0.1%.

According to a preferred variant of the process of the invention, the fermentation is carried out using lactic bacteria selected from among the genus types Lactobacillus delbrueckii sp. Bulgaricus, Streptococcus thermophilus.

Advantageously, the culture medium used in the process according to the invention contains 0.1 to 30%, preferably 0.1 to 25% and even more preferably 0.5 to 15% by weight of at least one fermentation activator saccharide selected from the group consisting of the maltodextrins, the branched maltodextrins, the soluble starches and the oligosaccharides, on their own or in a mixture.

The process according to the invention can be applied advantageously to the conversion of foodstuffs by fermentation, and in particular for the preparation of fermented milks and other dairy specialities, because the activator saccharide, which is not completely metabolised by the fermenting agents, confers advantageous rheological and nutritional properties on the finished products. In fact, the Applicant has observed that the process according to the invention, when applied to the preparation of dairy specialities, not only increases the fermentation rate but also improves their final texture. Moreover, when the activator saccharide is selected from among the oligosaccharides that contain soluble fibre, the latter can advantageously confer bifidogenic properties on the finished products and can constitute a supply of soluble fibre.

The process according to the invention can equally well be applied to the preparation of compositions for animal nutrition, such as silage in particular.

For this reason, the subject of the invention is also a process for preparing fermented food compositions characterised in that it comprises at least one stage consisting of employing a food fermenting agent production process according to the invention.

Another subject of the present invention is a process for preserving food fermenting agents characterised in that it uses at least one fermentation activator saccharide selected from the group consisting of the maltodextrins, the branched maltodextrins, the soluble starches and the oligosaccharides, on their own or in a mixture. In fact, the Applicant has observed that the said activator saccharide ensures that the bacteria have a satisfactory viability during storage. Thus the activator saccharide can be used advantageously as a support for preservation by drying, spraying, freezing and lyophilisation (freeze-drying) of the fermenting agents. Thus it can play its part as a fermentation activator all over again when the fermenting agent is put back into solution again.

Other benefits will be clearly apparent on reading the following example, which is intended to be illustrative and non-limiting.

### EXAMPLE 1

### Application to Fermented Milks

A fermented milk is prepared using traditional lactic fermenting agents (Lactobacillus delbrueckii sp. Bulgaricus and Streptococcus thermophilus) and the fermentation is followed by measuring the variation in the impedance of the medium during the incubation period (BACTOMETER®, BIOMERIEUX) and by the quantitative and qualitative determination of the microbial population by flow cytometry (CHEMFLOW®, CHEMUNEX). The BACTOMETER® system is a microbial detection system that is fast, reliable and sensitive and is entirely automated, based on the principles of microbiology by impedance. It is designed to detect the changes in impedance resulting from the metabolic activity of the growing micro-organisms. The measured detection time is a simultaneous function of the growth kinetics, the latency time and the concentration of micro-organisms in a given sample. The results are expressed in DT (Detection Time). The effect of various saccharides on the growth of the lactic fermentation agents is studied.

The growth medium has a volume of 1 ml, consisting of 9% milk, 10% saccharose (sucrose) and/or 10% of the saccharides to be studied. The milk is prepared by rehydrating milk powder in sterile water and is not pasteurised. The saccharides to be studied are sterilised by filtration.

The suspension of lactic fermenting agents is prepared in sterile water in order to obtain an initial population of 2×10⁶ CFU/ml of the milk medium. (CFU=colony-forming units) Incubation takes place at 44° C. for 24 hours. The variation of the impedance of the medium is measured continuously and converted into a % variation.

The results are recorded in the following Table.

| | | Detection time in |
|---|---|---|
| Saccharide | Concentration (%) | hours |
| None | | 4.6 |
| Saccharose (sucrose) | 10 | 4.6 |
| Glucose | 10 | 14.8 |
| GLUCIDEX ® 47 | 10 | 4.2 |
| GLUCIDIEX ® 21 | 10 | 3.8 |
| GLUCIDEX ® 6 | 10 | 3.3 |
| Soluble starch* | 10 | 3.4 |
| Galacto-oligosaccharides** | 10 | 4.1 |
| Isomalto-oligosaccharides*** | 10 | 4.1 |
| Fructo-oligosaccharides**** | 10 | 3.8 |
| Branched maltodextrins | 10 | 4.1 |

GLUCIDEX ® are the standard maltodextrins marketed by the Applicant.
*The soluble starch is a starch hydrolysed by an acid route and marketed by the MERCK Company under the Reference 1.01252.
**Galacto-oligosaccharides: Cup Oligo P ® - Nisshin Seito
***Isomalto-oligosaccharides: Isolmalt ®900P - Showa Sangyo
****Fructo-oligosaccharides: Actilight ®950P - Beghin-Meiji
Branched maltodextrins: a maltodextrin having between 15 and 35% of 1→6 glucosidic bonds, a reducing sugars content between 2 and 5% and an Mn between 2,000 and 3,000 g/mole is used.

The results show that the beneficial effect of the activator saccharides according to the invention is not related to a reduction in the osmotic pressure, because the detection time is identical to the control in the absence of saccharide in addition to milk lactose.

A reduction in the detection time corresponding to a decrease in the latency time is observed for the experiments in which the saccharose (sucrose) was replaced in particular by maltodextrins (GLUCIDEX®), soluble starch, branched maltodextrins and fructo-oligosaccharides.

### EXAMPLE 2

### Determination of the Bacterial Concentration

The lactic fermenting agents were used on the media described in the previous example (milk 9% and saccharose (sucrose) 10%, or activator saccharide 10%).

The incubation was carried out at 44° C. in a 2-liter reactor and the acidification kinetics were followed. Samples were taken during the fermentation to determine the total bacterial concentration and the viability of this population by using the CHEMFLOW analyser.

The fermentations were halted as soon as the pH had reached a value of 4.4.

The following Table shows the concentrations of total cells and the concentrations of living cells, the ratio between these two values giving the cellular viability. The analyses of the final samplings corresponding to the ends of the fermentations were carried out after stirring the yoghurt. The values are expressed in cells counted per ml of fermented medium.

| | | | | |
|---|---|---|---|---|
| | | | Fructo- | Branched |
| | Saccharose | GLUCI- | oligo- | malto- |
| Time (hours) | (sucrose) | DEX ®6 | saccharides | dextrins |

Total cells/living cells

| | | | | |
|---|---|---|---|---|
| 0 | 1.89 × 10⁸ | 1.92 × 10⁸ | 1 × 10⁸ | 1.67 × 10⁸ |
| | 1.46 × 10⁸ | 1.51 × 10⁸ | 0.8 × 10⁸ | 1.33 × 10⁸ |
| 1 | 3.28 × 10⁸ | 5.67 × 10⁸ | 1.75 × 10⁸ | 3.64 × 10⁸ |
| | 2.61 × 10⁸ | 4.49 × 10⁸ | 1.42 × 10⁸ | 2.98 × 10⁸ |
| 2 | 3.14 × 10⁸ | 7.27 × 10⁸ | 2.49 × 10⁸ | 6.24 × 10⁸ |
| | 2.54 × 10⁸ | 5.68 × 10⁸ | 2.01 × 10⁸ | 4.88 × 10⁸ |
| 3 | 5.81 × 10⁸ | 9.86 × 10⁸ | 4.32 × 10⁸ | 12.9 × 10⁸ |
| | 4.17 × 10⁸ | 8.4 × 10⁸ | 2.89 × 10⁸ | 10.5 × 10⁸ |
| 4 | 7.8 × 10⁸ | 22.4 × 10⁸ | 8.41 × 10⁸ | 33.8 × 10⁸ |
| | 6.3 × 10⁸ | 15.4 × 10⁸ | 6.57 × 10⁸ | 23.3 × 10⁸ |
| 4.25 | — | 37.4 × 10⁸ | — | 34.1 × 10⁸ |
| | | 25.8 × 10⁸ | | 22.2 × 10⁸ |
| | | 67% | | 65% |
| 4.33 | — | — | 8.5 × 10⁸ | — |
| | | | 7.5 × 10⁸ | |
| 4.5 | — | — | 14 × 10⁸ | — |
| | | | 11.5 × 10⁸ | |
| | | | 82% | |
| 5 | 10.5 × 10⁸ | — | — | — |
| | 7.2 × 10⁸ | | | |
| | 68% | | | |

The viabilities for each of the media are calculated by taking the ratio between the living cells and the total cells, expressed as a percentage. The viabilities are 68, 67, 82 and 65% respectively. Depending on the activator saccharide used, the viable cell concentrations are 1.6 to 3.6 times more concentrated than the saccharose (sucrose) control, the GLUCIDEX®6 and the branched maltodextrins being the strongest growth activators. In fact, the time needed to obtain a pH of 4.4 is distinctly shorter: 4.25 hours with GLUCIDEX®6 and branched maltodextrins and 4.5 hours with the fructo-oligosaccharides, whereas it needs 5 hours when saccharose (sucrose) is used.

### EXAMPLE 3

Experiments were performed under the conditions of Example 1 but with a variation in the concentrations of GLUCIDEX®, without saccharose (sucrose) and with the addition of intense sweeteners.

The results are presented in the following Table:

| | CONCENTRATION | Detection time |
|---|---|---|
| SACCHARIDE | (%) | (hours) |
| Saccharose (sucrose) | 10 | 3.9 |
| GLUCIDEX ®6 | 0 | 3.9 |
| | 2 | 3.4 |
| | 4 | 3.1 |
| | 6 | 2.9 |
| | 8 | 2.7 |
| | 10 | 2.7 |
| GLUCIDEX ®6 + sweeteners | 10 | 2.7 |

A reduction of 30% in the latency time is observed for concentrations of GLUCIDEX®6 greater than 8%. The addition of intense sweeteners does not change the result.

When the concentrations of GLUCIDEX®6 and of saccharose (sucrose) are varied for a total concentration of 10%, the following results are obtained:

| SACCHAROSE | | Detection time |
|---|---|---|
| (SUCROSE) (%) | GLUCIDEX ®6 (%) | (hours) |
| 10 | 0 | 3.9 |
| 8 | 2 | 3.7 |
| 6 | 4 | 3.3 |
| 4 | 6 | 2.9 |
| 2 | 8 | 2.6 |
| 0 | 10 | 2.4 |

The use of activator saccharides according to the invention in the fermentation medium allows:

a reduction in the latent period of bacterial growth,

a faster acidification with a saving in the fermentation time necessary to obtain a pH of 4.4,

a bacterial population 2 to 4 times greater in number and having increased viability.

1. Process for producing food fermenting agents comprising a fermentation of lactic bacteria in a culture medium, wherein said culture medium comprises at least one fermentation activator saccharide selected from the group consisting of the maltodextrins, the branched maltodextrins, the soluble starches and the oligosaccharides, on their own or in a mixture.

2. Process according to claim 1, wherein the said activator saccharide is present in the culture medium at a concentration at least equal to 0.1% by weight.

3. Process according to claim 1, wherein the lactic bacteria are selected from the genus types Lactobacillus delbrueckii sp. Bulgaricus and Streptococcus thermophilus.

4. Process according to claim 1, wherein the culture medium contains 0.1 to 30%, preferably 0.1 to 25% and even more preferably 0.5 to 15% by weight of at least one fermentation activator saccharide selected from the group consisting of the maltodextrins, the branched maltodextrins, the soluble starches and the oligosaccharides, on their own or in a mixture.

5. Process for preparing fermented food compositions which comprises at least one step consisting of using the process of claim 1.

6. Food composition obtainable in accordance with a process according to claim 5.

7. Food composition according to claim 6, which is a fermented milk.

8. Process for preserving food fermenting agents which uses at least one fermentation activator saccharide selected from the group consisting of the maltodextrins, the branched maltodextrins, the soluble starches and the oligosaccharides, on their own or in a mixture.

9. Preservation process according to claim 8, which is a lyophilisation.

10. Process for the production of food fermenting agents comprising a lactic bacteria fermentation in a culture medium, wherein said culture medium comprises at least one fermentation activator saccharide selected from the group consisting of the branched maltodextrins, the soluble starches and the oligosaccharides, on their own or in a mixture.
